(19) United States
(12) Patent Application Publication
(10) Pub. No.: US 2021/0107381 A1
(43) Pub. Date: Apr. 15, 2021

(54) GUIDE RAIL ASSEMBLY FOR A LONGITUDINAL ADJUSTMENT OF A VEHICLE SEAT

(71) Applicant: Brose Fahrzeugteile GmbH & Co. Kommanditgesellschaft, Coburg, Coburg (DE)

(72) Inventor: Gregor KROENER, Bischberg (DE)

(73) Assignee: Brose Fahrzeugteile GmbH & Co. Kommanditgesellschaft, Coburg, Coburg (DE)

(21) Appl. No.: 16/496,090

(22) PCT Filed: Mar. 16, 2018
(86) PCT No.: PCT/EP2018/056630

§ 371 Date: Sep. 20, 2019

(30) Foreign Application Priority Data
Mar. 21, 2017 (DE) 10 2017 204 736.4

(51) Int. Cl. B60N 2/07; B60N 2/01; B60N 2/02

(52) U.S. Cl. CPC B60N 2/0715; B60N 2/0292; B60N 2/072; B60N 2/01

(57) ABSTRACT

A guide rail assembly for a longitudinal adjustment of a vehicle seat, comprising a lower rail, which can be connected to a vehicle floor and which has a first profiled guide, and an upper rail, which can be connected to a vehicle seat and which has a second profiled guide that is guided on the first profiled guide along an adjustment direction. The lower rail or the upper rail has a third profiled guide which extends along the adjustment direction for guiding an assembly in addition to the vehicle seat. In this manner, a guide rail assembly is provided which allows a flexible adjustability of an assembly in addition to a vehicle seat.

### CROSS-REFERENCE TO RELATED APPLICATIONS

This application is the U.S. National Phase of PCT/EP2018/056630 filed Mar. 16, 2018, which claims priority to DE 10 2017 204 736.4 filed Mar. 21, 2017, the disclosures of which are hereby incorporated in their entirety by reference herein.

### TECHNICAL FIELD

The present disclosure relates to a guide rail assembly for a longitudinal adjustment of a vehicle seat.

### BACKGROUND

A guide rail assembly may include a lower rail, that may be connected to a vehicle floor and which has a first guide profile, and an upper rail, that may be connected to a vehicle seat and which has a second guide profile, which is longitudinally guided on the first guide profile along an adjustment direction.

Vehicle seats, in particular vehicle front seats, may be adjusted relative to a vehicle floor via guide rails, in order to be able to set a longitudinal position of each vehicle seat. A vehicle front seat is thereby usually guided in a longitudinally adjustable manner via two guide rail pairs, namely a tunnel-side guide rail pair (which is located towards the vehicle center) and a door-side guide rail pair (which is located towards the vehicle side door), wherein the vehicle seat is directly or indirectly connected to the upper rails of the guide rail pairs (for example via a height adjustment device), while the lower rails of the guide rail pairs are secured directly or indirectly to a vehicle floor. Each vehicle seat can be adjusted manually or electromotively along the guide rail pairs, so that a user can set a desired, comfortable seat position in this way.

### SUMMARY

One or more objects of the present application may be to provide a guide rail assembly, that may provide a flexible settability of an assembly group, in addition to a vehicle seat.

According to this, the lower rail or the upper rail may include a third guide profile extended along the adjustment direction for guiding an assembly group, in addition to the vehicle seat.

An additional guide profile, which serves to guide the further assembly group, for example a glove box, a container or also a display device, for example a display, is to thus be created on the lower rail or the upper rail. An additional assembly group may be adjustable, for example between vehicle front seats via the guide rail assembly, that may increase the comfort for a vehicle passenger and which makes it possible to bring an assembly group into a desired position in a flexible manner.

Due to the fact that the third guide profile, which serves to guide the additional assembly group, is integrated in the upper rail or the lower rail, an additional, separate guide rail does not need to be assembled for a longitudinal adjustment of the additional assembly group, that may facilitate the assembly of vehicle seats, including the additional assembly group, which is to be adjusted.

By providing a further, additional guide profile on the lower rail or the upper rail, an increased stability of the guide rail assembly may be attained as further advantage. By the doubling of the guide profiles on the lower rail or the upper rail, a reinforcement is made possible, which contributes to an increased stability and which possibly provides for the use of other types of constructions or other materials for producing the guide rail assembly.

The additional assembly group are be connected, for example, to a fourth guide profile, which is guided on the third guide profile along the adjustment direction. The additional assembly group are thus be adjusted along the adjustment direction by guiding the fourth guide profile on the third guide profile, and the position thereof may be set in a flexible manner.

The first guide profile of the lower rail, the second guide profile of the upper rail, and also the third guide profile, which is part of the lower rail or of the upper rail, are each embodied in the manner of guide rails extended longitudinally along the adjustment direction. The guide profiles can thereby be of different lengths, viewed along the adjustment direction, wherein a guide profile, for example the second guide profile of the upper rail, may for example also be embodied to be short as compared to the other guide profile, for example to the first guide profile of the lower rail. By means of guidance on the first guide profile of the lower rail, the second guide profile of the upper rail is longitudinally guided along the adjustment path specified by the first guide profile of the lower rail, and the vehicle seat, which is connected to the upper rail, are thus be longitudinally adjusted.

The vehicle seat may be secured directly or also indirectly to the upper rail, for example via a height adjustment device. The lower rail may likewise be connected directly or also indirectly to the vehicle floor via an interconnected assembly group.

The third guide profile is firmly connected to the assigned guide profile of the lower rail or of the upper rail. Different alternatives for this are conceivable.

In one embodiment, the third guide profile are for example be embodied in one piece with the first guide profile or the second guide profile. When the third guide profile is part of the lower rail, the lower rail may for example be made in one piece by embodying the first guide profile and the third guide profile as extrusion, for example of aluminum. Alternatively, when the third guide profile is part of the upper rail, the upper rail may be embodied as integral extrusion with its second guide profile and the third guide profile. The third guide profile is thus formed in one piece as integral component part with the assigned guide profile of the lower rail or of the upper rail.

Instead of as extrusion, the third guide profile may also be embodied as curved sheet metal part, together with the assigned first or second guide profile of the lower rail or of the upper rail. The third guide profile is thus also formed in one piece with the assigned guide profile of the lower rail or of the upper rail in this case.

In an alternative embodiment, the third guide profile may also be made as separate profile element to the assigned first or second guide profile, and may be connected to the assigned first or second guide profile by means of a substance-to-substance bond, in a positive or non-positive manner only in a further processing step. The third guide profile is thus also firmly connected to the assigned first or second guide profile in this case, but not by means of an integral production, but by means of a substance-to-substance bond, positive or non-positive connection, for example by means of adhesion, welding or screwing.

A vehicle seat assembly may have, for example, a first vehicle seat and a second vehicle seat, which is arranged transversely to the adjustment direction next to the first vehicle seat. The vehicle seats may realize, for example, front seats or also back seats in a vehicle. The additional assembly group may be arranged, for example, between the first vehicle seat and the second vehicle seat in this case and may realize, for example, a console element, a glove compartment or a display device.

The first vehicle seat may be guided longitudinally along the adjustment direction relative to a vehicle floor via a first guide rail assembly of the above-described type, and the second vehicle seat via a second guide rail assembly of the above-described type. The additional assembly group, for example a console element, a glove compartment or a display device, may thereby be guided longitudinally along the adjustment direction on a third guide profile of the first guide rail assembly and/or on a third guide profile of the second guide rail assembly, so that an adjustability of the assembly group between the vehicle seats is created via the guidance of the assembly group on both guide rail assemblies or on only one guide rail assembly.

In one embodiment, the additional assembly group may be guided longitudinally along the adjustment direction either on a third guide profile of the first guide rail assembly or on a third guide profile of the second guide rail assembly. The additional assembly group may be longitudinally guided only on one of the guide rail assemblies, but not on the respective other one, and the respective other guide rail assembly accordingly also does not have a third guide profile. On the other guide rail assembly, the additional assembly group, for example a console element or the like, may run, e.g., via a wheel or the like (without being guided in a third guide profile).

If, in another embodiment, the additional assembly group is guided on the third guide profile of the first guide rail assembly and also on the third guide profile of the second guide rail assembly, a bilateral guidance of the additional assembly group results between the vehicle seats. To lock the longitudinal position of the additional assembly group in place, a locking device may be provided on one of the guide rail assemblies, or, alternatively, locking devices may also be provided on both guide rail assemblies, so that the additional assembly group is locked on both sides and may be secured in its longitudinal position.

If a locking device for locking the additional assembly group is provided on each guide rail assembly, the locking devices may be operated jointly, so that the additional assembly group may be set in a simple manner in its longitudinal position by means of jointly unlocking both locking devices.

If the third guide profiles are part of the lower rails of the guide rail assemblies, an adjustment of a vehicle seat may take place independently of the additional assembly group. No additional measures are thus required in order to coordinate an adjustment of a vehicle seat with an adjustment of the additional assembly group.

Something else results, when the third guide profiles are part of the upper rails of the guide rail assemblies. In this case, an adjustment of a vehicle seat relative to the other vehicle seat may require that a locking device, by means of which the additional assembly group may be locked to one of the third guide profiles, where appropriate, is unlocked, so that the vehicle seat may be moved independently of the additional assembly group or, alternatively, together with the additional assembly group in response to the unlocking of the additional assembly group from the other vehicle seat. For coordinating the operation of the locking devices of the additional assembly group and of one or a plurality of locking devices of one or both vehicle seats, a control device may be provided, which mechanically or electronically controls an operation of the locking devices.

The locking devices may in each case for example be capable of being electromotively operated. The control device may electronically control the operating processes in this case, in order to provide for the adjustment of one or of both vehicle seats and/or of the additional assembly group.

In the case of the vehicle seat assembly, a plurality of vehicle seats may be guided on one guide rail assembly. A third vehicle seat, viewed along the adjustment direction, may thus be arranged behind the first vehicle seat and is guided on the first guide rail assembly in this case. Additionally or alternatively, a fourth vehicle seat, viewed along the adjustment direction, may be arranged behind the second vehicle seat and is guided on the second guide rail assembly in this case. The guide rail assemblies thus serve to adjust a plurality of vehicle seats along a joint guide track, which increases the flexibility in response to the adjustment of vehicle seats located behind one another, in particular also with regard to vehicle seat assemblies, in the case of which the viewing direction may be changed, for example from a viewing direction to the front to a viewing direction to the back in connection with the autonomous driving of vehicles.

### BRIEF DESCRIPTION OF THE DRAWINGS

The idea, on which the invention is based, is to be described in more detail below on the basis of the exemplary embodiments illustrated in the figures, in which

FIG. 1 shows a schematic illustration of a vehicle seat assembly, comprising two vehicle seats, which are arranged next to one another and which are guided on guide rail assemblies;

FIG. 2 shows a schematic view of an additional assembly group between two vehicle seats;

FIG. 3 shows a schematic view of a guide rail assembly according to a first exemplary embodiment;

FIG. 4 shows a schematic view of a guide rail assembly according to a second exemplary embodiment;

FIG. 5 shows a schematic view of a guide rail assembly according to a third exemplary embodiment;

FIG. 6 shows a schematic view of an additional assembly group between two vehicle seats, according to another exemplary embodiment;

FIG. 7 shows a schematic view of a vehicle seat assembly comprising front vehicle seats and rear vehicle seats, which are guided on guide rail assemblies; and

FIG. 8 shows a schematic view of a vehicle seat assembly comprising vehicle seats, which are guided on guide rail assemblies, according to another exemplary embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the case of conventional vehicle seat assemblies, a relative adjustment of the vehicle seat to the center console results in response to an adjustment of a vehicle seat, in particular of a vehicle front seat, which may be undesirable. In connection with autonomously driving vehicles, concepts are furthermore contemplated, in the case of which vehicle seats may be rotated in their viewing direction, which will also have impacts on the interior design. There might thus be a need for being able to adjust the position of individual assemblies, e.g. on a center console, in a flexible manner.

A center console is usually arranged between vehicle front seats. In the case of a vehicle seat assembly known from DE 103 35 292 A1, it is provided in this respect to guide a box in a longitudinally displaceable manner on a center tunnel.

A vehicle seat assembly comprising a center console arranged between vehicle front seats is furthermore known from DE 10 2008 044 180 A1.

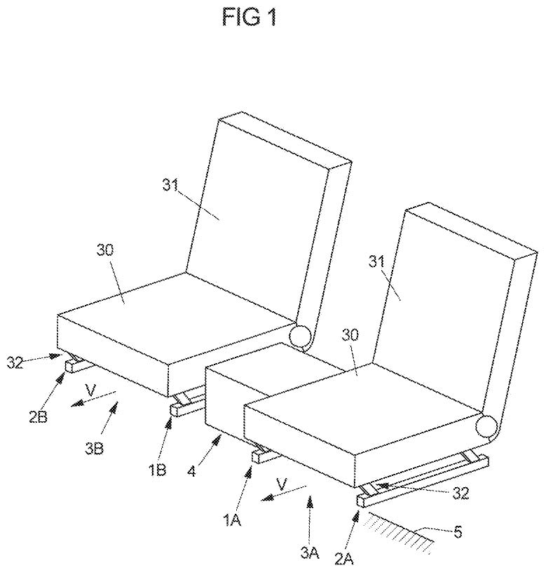

In a schematic view, FIG. 1 shows a vehicle seat assembly, in the case of which two vehicle seats 3A, 3B, which are arranged next to one another, are in each case fastened to a vehicle floor 5 via guide rail assemblies 1A, 2A, 1B, 2B and may in each case be adjusted longitudinally along an adjustment direction V relative to the vehicle floor 5 via the guide rail assemblies 1A, 2A, 1B, 2B.

The vehicle seats 3A, 3B may be, for example, front seats in a vehicle. However, the vehicle seats 3A, 3B may also be back seats of a second or third row in a vehicle.

As usual, each vehicle seat 3A, 3B has a seat part 30 and a backrest part 31. In the illustrated exemplary embodiment, the seat part 30 is fastened to two guide rail assemblies 1A, 2A, 1B, 2B extended parallel to one another along the adjustment direction V so as to be height-adjustable via a height adjustment device 32, and is held in a set position relative to the vehicle floor 5 via said height adjustment device.

Each guide rail assembly 1A, 2A, 1B, 2B has a vehicle-side upper rail and a vehicle floor-side lower rail. The upper rail is guided longitudinally along the adjustment direction V on the lower rail and may be adjusted longitudinally along the adjustment direction V relative to the lower rail in order to set the longitudinal position of the respectively assigned vehicle seat 3A, 3B.

An assembly group 4, which is only illustrated schematically in FIG. 1 and that may be a console element, for example, such as, for example, a glove compartment or also a display device in the form of a display or the like, is arranged between the vehicle seats 3A, 3B.

While the outer, door-side guide rail assemblies 2A, 2B of the vehicle seats 3A, 3B may be embodied in the conventional manner, each comprising an upper guide profile assigned to the vehicle seat 3A, 3B, and a lower guide profile assigned to the vehicle floor 5, the inner, tunnel-side guide rail assemblies 1A, 1B serve the purpose of longitudinally guiding the respectively assigned vehicle seat 3A, 3B on the one hand, but additionally also for the purpose of adjusting the additional assembly group 4 on the other hand, in terms of the present disclosure.

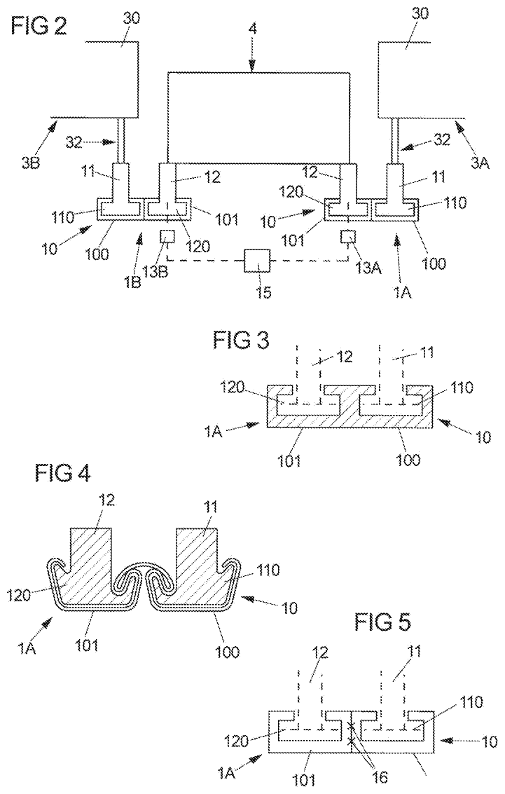

In the case of an exemplary embodiment illustrated in FIG. 2, the inner, tunnel-side guide rail assemblies 1A, 1B of the vehicle seats 3A, 3B in each case have a lower rail 10, which consists of two guide profiles 100, 101, which are arranged next to one another and which are firmly connected to one another. A second guide profile 110 of an assigned upper rail 11 of the assigned vehicle seat 3A, 3B is thereby guided on a first guide profile 100 of the lower rail 10, while a fourth guide profile 120 of an upper rail 12 assigned to the additional assembly group 4 is longitudinally guided on a third guide profile 101. Each inner, tunnel-side guide rail assembly 1A, 1B thus serves the purpose of guiding the assigned vehicle seat 3A, 3B on the one hand, but also of guiding the additional assembly group 4 arranged between the vehicle seats 3A, 3B on the other hand, so that the additional assembly group 4 may be adjusted along the adjustment direction V between the vehicle seats 3A, 3B due to the longitudinal guidance via the guide rail assemblies 1A, 1B.

Different advantages result due to the fact that two guide profiles 100, 101 are part of the lower rail 10.

Firstly, the lower rail 10, together with the upper rails 11, 12 arranged thereon, may be assembled in the vehicle in a uniform manner, thus resulting in a simple assembly of a guide system for the vehicle seats 3A, 3B as well as for the additional assembly group 4 arranged therebetween.

Secondly, the doubling of the guide profiles 100, 101 on the lower rail 10 effects a reinforcement, which makes it possible to provide an increased stability on the lower rail 10 and thus also on the respective guide rail assembly 1A, 1B as a whole, and which possibly allows for the use of materials other than the currently usual materials.

The guide profiles 100, 101 in each case extend longitudinally along the adjustment direction V in the manner of rails and thus provide parallel guide tracks for the assigned vehicle seat 3A, 3B on the one hand and for the additional assembly group 4 on the other hand. As illustrated in FIG. 2, the additional assembly group 4 is thereby guided parallel on the two guide profiles 101 of the lower rails 10 of the guide rail assemblies 1A, 1B, so that the additional assembly group 4 is bilaterally supported on both guide rail assemblies 1A, 1B.

The guide profiles 100, 101 of the lower rails 10 are firmly connected to one another. Different alternatives are conceivable and possible thereby.

In an exemplary embodiment illustrated in FIG. 3, the lower rail 10 is embodied as one-piece, integral component part, for example by means of extrusion molding, for example aluminum extrusion molding. The lower rail 10 is thus embodied as extrusion comprising integrally molded guide profiles 100, 101.

In the case of this exemplary embodiment, the lower rails 10 on the one hand and the upper rails 11, 12 on the other hand may be made of different materials. The lower rails 10 may thus be made, for example, of aluminum, for example as aluminum extrusions, while the upper rails 11, 12 are embodied by steel rails.

In the case of an exemplary embodiment illustrated in FIG. 4, the lower rail 10, in contrast, is embodied as curved sheet metal part. The lower rail 10, in turn is made as integral, one-piece component part.

In the case of an exemplary embodiment illustrated in FIG. 5, the lower rail 10 is made of two guide profiles 100, 101, which are firmly connected to one another, but which are initially produced separately. The guide profiles 100, 101 are connected to one another, for example by means of substance-to-substance bond, positively or non-positively, for example by means of adhesion, welding or screwing. A firm connection is thus created between the guide profiles 100, 101 at punctiform, linear or flat fastening locations 16, so that the lower rail 10 may be assembled to the vehicle floor 5 as uniform component part.

If the guide profiles 101 for guiding the upper rails 12 of the additional assembly group 4 are part of the lower rails 10 of the guide rail assemblies 1A, 1B, an independent adjustment of the front seats 3A, 3B and of the assembly group 4 is readily possible. The additional assembly group 4 may thereby be locked via locking devices 13A, 13B in a longitudinal position, which has just been assumed, in that the upper rails 12 are locked in place in their position to the guide profiles 101. The additional assembly group 4 may be adjusted along the adjustment direction V by unlocking the locking devices 13A, 13B, possibly controlled via a control device 15.

The locking devices 13A, 13B may have any shape and mechanically lock the upper rails 12 of the additional assembly group 4 to the guide profiles 101 of the lower rails 10. By means of jointly operating the locking devices 13A, 13B, an adjustment of the additional assembly group 4 along the adjustment direction V is made possible, whereby the joint operation may take place via a suitable mechanical system, for example an operating rod or a Bowden cable assembly. It is also conceivable and possible, however, to embody the control device 15 by means of a suitable electronics assembly, which electronically controls the locking devices 13A, 13B for unlocking.

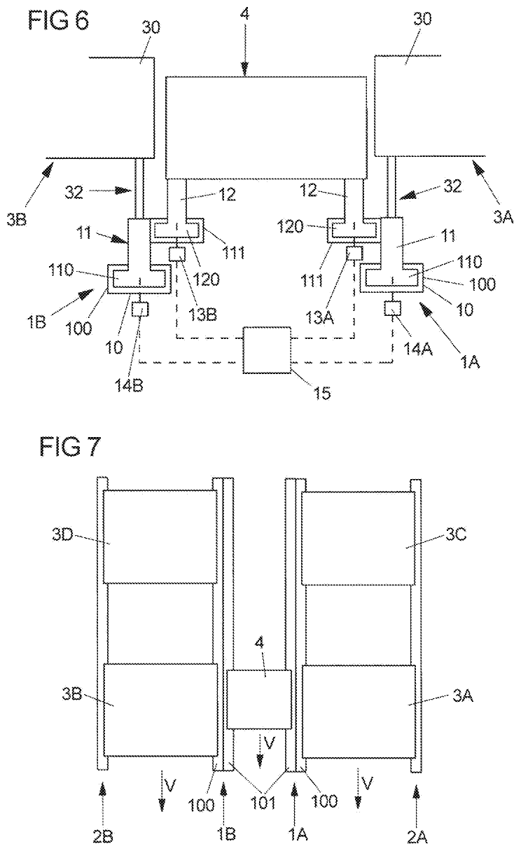

While the additional, third guide profiles 101 are part of the lower rails 10 in the case of the exemplary embodiment according to FIG. 2, additional guide profiles 111 are part of the upper rails 11 of the guide rail assemblies 1A, 1B in the case of the exemplary embodiment according to FIG. 6. The lower rails 10 of the guide rail assemblies 1A, 1B thus in each case consist only of a single guide profile 100, on which a guide profile 110 of the assigned upper rail 11 is guided on the side of the respective vehicle seat 3A, 3B. A further guide profile 111, on which an upper rail 12 of the additional assembly group 4 is guided longitudinally along the adjustment direction V, is thereby firmly arranged on each upper rail 11.

In the case of this exemplary embodiment, an adjustment of the additional assembly group 4 thus takes place to the upper rails 12 of the guide rail assemblies 1A, 1B. This has impacts on an operation of locking devices 13A, 13B for locking the additional assembly group 4 and also on an operation of locking devices 14A, 14B for locking the vehicle seats 3A, 3B.

Different alternatives are conceivable.

It is initially conceivable that only a single locking device 13A, 13B is present for locking the additional assembly group 4. A locking of only one of the upper rails 12 with the assigned guide profile 111 takes place in this case, so that the additional assembly group 4 is only locked in place on one side. As a result, only this one locking device 13A, 13B has to be released for an adjustment of the additional assembly group 4 when vehicle seats 3A, 3B are stationary.

If a vehicle seat 3A, 3B is to be adjusted, a decision as to whether the additional assembly group 4 is also moved, depends on which vehicle seat 3A, 3B is unlocked and moved. If the additional assembly group 4 is locked, for example, only to the upper rail 11 on the side of the vehicle seat 3A via the locking device 13A (and if the other locking device 13B is not present), the additional assembly group 4 is also moved, when the locking device 14A is unlocked and the vehicle seat 3A is longitudinally adjusted. If, in contrast, the locking device 14B of the vehicle seat 3B is unlocked and if the vehicle seat 3B is adjusted, the additional assembly group 4 remains stationary with the vehicle seat 3A.

If, in contrast, two locking devices 13A, 13B are present for locking the additional assembly group 4, one of the locking devices 13A, 13B has to be unlocked when one of the front seats 3A, 3B is to be adjusted. Different control concepts are conceivable thereby.

It may be provided, for example, that the additional assembly group 4 is to always maintain the relative position to a certain one of the vehicle seats 3A, 3B, for example the driver's-side vehicle seat 3A, in response to an adjustment of each of the vehicle seats 3A, 3B. If the driver's-side vehicle seat 3A is adjusted and if the locking device 14A is unlocked for this purpose, the locking device 13B assigned to the additional assembly group 4 on the side of the other vehicle seat 3B is also unlocked via a control device 15, so that the additional assembly group 4 may be moved relative to the other, passenger-side vehicle seat 3B, together with the vehicle seat 3A. If, vice versa, the locking device 14B of the passenger-side vehicle seat 3B is unlocked in order to adjust the passenger-side vehicle seat 3B, the locking device 13B of the additional assembly group 4 on the side of the passenger-side vehicle seat 3B is also unlocked via the control device 15, so that the passenger-side vehicle seat 3B may be adjusted relative to the additional assembly group 4 (and relative to the driver's-side vehicle seat 3A).

The control device 15 may, e.g., be embodied electronically in this case and may electronically control the locking devices 13A, 13B, 14A, 14B, for example for unlocking by operation of electromotive actuators.

In the case of the assemblies according to FIGS. 2 and 6, it is also conceivable in another embodiment that the additional assembly group 4 is longitudinally guided only on one of the guide rail assemblies 1A, 1B. Only one of the guide rail assemblies 1A, 1B then accordingly has a third guide profile 101, on which the additional assembly group 4 is guided via a guide profile 120. On the side of the other guide rail assembly 1B, 1A, the additional assembly group 4 may be supported, for example via a wheel in this case (but not guided in a guide profile 101), which rolls in response to the movement of the additional assembly group 4.

The guide rail assemblies 1A, 1B, 2A, 2B may serve the purpose of guiding a plurality of vehicle seats 3A, 3B, 3C, 3D, which are arranged behind one another, as it is illustrated in FIG. 7. In the case of the tunnel-side guide rail assemblies 1A, 1B, for example the lower rails 10 may thereby in each case have two guide profiles 100, 101, which extend longitudinally along the entire length of the guide rail assemblies 1A, 1B. The additional assembly group 4 may be adjusted along the adjustment direction V between the front vehicle seats 3A, 3B and also between the back vehicle seats 3C, 3D.

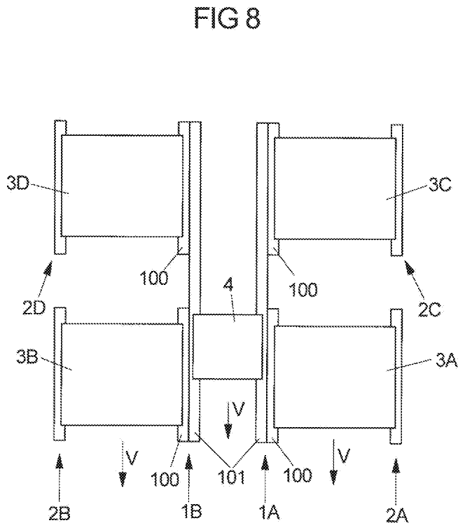

In the case of an exemplary embodiment illustrated in FIG. 8, the guide profiles of the guide rail assemblies 1A, 1B, 2A, 2B, which are assigned to the vehicle seats 3A, 3B, 3C, 3D, are interrupted. The guide profiles 101 of the tunnel-side guide rail assemblies 1A, 1B, however, extend from the front vehicle seats 3A, 3B to the back vehicle seats 3C, 3D, so that the additional assembly group 4, in turn, may be adjusted between the front vehicle seats 3A, 3B and the back vehicle seats 3C, 3D.

The idea is not limited to the above-described exemplary embodiments, but may also be realized in a completely different manner.

Guide rail assemblies, as they have been described here, may be advantageous in particular with regard to autonomously driving vehicles. An additional assembly group may include for example a display device, on which operating information, for example information usually displayed on an instrument panel, may be displayed. By adjusting the additional assembly group from a front into a rear position, operation-relevant information, for example speed, rotational speed or a battery charge status may be displayed when a driver's seat has been rotated from a usual driving position into a position with viewing direction to the back.

The additional assembly group may, for example, also be a device for playing and/or controlling media. The additional assembly group may have, for example, a screen, via which movies can be played. By adjustment between front and back vehicle seats, the screen may then, where appropriate, be brought into a flexible, desired position in the vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMERALS

1A, 1B guide rail assembly
10 lower rail
100, 101 guide profile
11 upper rail
110, 111 guide profile
12 upper rail
120 guide profile
13A, 13B, 14A, 14B locking device
15 control device
16 fastening point
2A-2D guide rail assembly
3A-3D vehicle seat
30 seat part
31 backrest part
32 height adjustment device
4 assembly group (console element)
5 vehicle floor
V adjustment direction

1. A guide rail assembly for longitudinal adjustment of a vehicle seat, the guide rail assembly comprising:
a lower rail configured to be connected to a vehicle floor and forming a first guide profile; and
an upper rail configured to be connected to the vehicle seat and forming a second guide profile, wherein the second guide profile is guided longitudinally along the first guide profile in an adjustment direction,
wherein either
the lower rail or the upper rail forms a third guide profile extending along the adjustment direction and configured to guide an assembly group and the vehicle seat.

2. The guide rail assembly of claim 1, further comprising a fourth guide profile configured to be connected to the assembly group and configured to be guided on the third guide profile along the adjustment direction.

3. The guide rail assembly of claim 1, wherein the third guide profile is formed as one piece with either the first guide profile or the second guide profile.

4. The guide rail assembly of claim 1, wherein the third guide profile is extruded with the first guide profile or the second guide profile.

5. The guide rail assembly of claim 1, wherein the third guide profile and the first guide profile and/or the second guide profile are formed from a curved sheet metal part.

6. The guide rail assembly of claim 1, wherein the third guide profile is connected to the first guide profile or the second guide profile by means of a substance-to-substance bond, in a positive or non-positive manner.

7. (canceled)

8. (canceled)

9. A vehicle seat assembly comprising:
a first vehicle seat
a first guide rail assembly, wherein the first vehicle seat is configured to be guided longitudinally along the first guide rail assembly in an adjustment direction;
a second vehicle seat arranged transversely to an adjustment direction next to the first vehicle seat;
a second guide rail assembly, wherein the second vehicle seat is configured to be guided longitudinally along the second guide rail assembly in the adjustment direction; and
an additional assembly group arranged between the first vehicle seat and the second vehicle seat, wherein the additional assembly group is guided longitudinally in the adjustment direction along a third guide profile of the first guide rail assembly and/or of the second guide rail assembly.

10. The vehicle seat assembly of claim 9, wherein the additional assembly group is guided on the third guide profile of either the first guide rail assembly or the second guide rail assembly.

11. The vehicle seat assembly of claim 9, further comprising a first locking device configured to lock the additional assembly group to the third guide profile of the first guide rail assembly to secure a longitudinal position of the additional assembly group.

12. The vehicle seat assembly of claim 15, wherein the first locking device and the second locking device are each configured to be operated jointly.

13. The vehicle seat assembly of claim 15, further comprising a control device configured to operate the first locking device and/or the second locking device to secure a longitudinal position of at least one of the first and second vehicle seats.

14. The vehicle seat assembly of claim 9, further comprising a third vehicle seat disposed behind the first vehicle seat with respect to the adjustment direction, wherein the third vehicle seat is configured to be guided along the first guide rail assembly.

15. The vehicle seat assembly of claim 9, further comprising a second locking device configured to lock the additional assembly group to the third guide profile of the second guide rail assembly to secure a longitudinal position of the additional assembly group.

16. The vehicle seat assembly of claim 14, further comprising a fourth vehicle seat disposed behind the second vehicle seat with respect to the adjustment direction, wherein the fourth vehicle seat is configured to be guided along the second guide rail assembly.

17. A vehicle seat assembly comprising:
a first vehicle seat including,
a first seat part,
a first lower rail configured to be connected to a vehicle floor, and
a first upper rail connected to the first seat part and configured to move longitudinally along the first lower rail in an adjustment direction; and
a console assembly including, a second lower rail fixed directly to the first upper rail, and
a second upper rail configured to move longitudinally along the second lower rail in the adjustment direction.

18. The vehicle seat assembly of claim 17, further comprising:
a second vehicle seat including,
a second seat part,
a third lower rail configured to be connected to the vehicle floor, and
a third upper rail configured to move longitudinally along the third lower rail in the adjustment direction, wherein the console assembly includes a fourth lower rail, directly connected to the third upper rail, and a fourth upper rail configured to move longitudinally along the fourth lower rail in the adjustment direction.

19. The vehicle seat assembly of claim 18, further comprising a first locking device coupled to the second lower rail and configured to lock and unlock the second upper rail to the second lower rail in one or more positions of the third upper rail.

20. The vehicle seat assembly of claim 19, further comprising a second locking device coupled to the third lower rail and configured to lock and unlock the third upper rail to the third lower rail in one or more positions of the third upper rail.
